(19) United States
(12) Patent Application Publication
(10) Pub. No.: US 2008/0099218 A1
(43) Pub. Date: May 1, 2008

(54) Air actuated down-the-hole hammer for rock drilling, a drill bit and a foot valve to be used in the down-the-hole hammer

(75) Inventor: Rob Simmons, Arlington, TX (US)

Correspondence Address: DRINKER BIDDLE & REATH (DC), 1500 K STREET, N.W., SUITE 1100, WASHINGTON, DC, 20005-1209, US

(73) Assignee: Sandvik Intellectual Property AB

(21) Appl. No.: 11/586,722

(22) Filed: Oct. 26, 2006

(51) Int. Cl. B23Q 5/00

(52) U.S. Cl. 173/13

(57) ABSTRACT

The present invention relates to a percussive down-the-hole hammer, a drill bit and a foot valve. The drill bit includes a body having a front drilling face, a central passage extending from a rear end of the body in a direction towards the drilling face to conduct flushing medium to the drilling face. The rear end includes an impact surface surrounding the passage. The central passage is adapted to receive a foot valve to transfer pressurized air through the drill bit. The foot valve and the central passage include insertion stop means and major extraction stop means for the foot valve. The insertion stop means are provided at a distance from the major extraction stop means.

### FIELD OF THE INVENTION

The present invention relates generally to an air actuated down-the-hole hammer for rock drilling, a drill bit and a foot valve to be used in the down-the-hole hammer.

### BACKGROUND OF THE INVENTION

When drilling with down-the-hole hammers under ground, such as in tunnels, the dust generated by the drilling operation often is bound by the use of water mixed into the pressurized air driving the hammer and flushing the dust away. The down-the-hole hammer is provided with a plastic foot valve located in a central passage in a drill bit anvil and projecting from an impact surface of the anvil. The foot valve is repeatedly enclosed by a central bore of a reciprocating piston to transfer spent pressurized driving air through the drill bit. An example of such a technique is disclosed in U.S. Pat. No. 6,125,952, the subject matter of which is hereby incorporated by reference for disclosure of the down-the-hole hammer technique. During drilling, the piston can unseat the foot valve from the bit shank body when it begins the upward stroke due to wear from long run deep hole drilling applications, tolerance differences from different manufacturers, and the debris that may come between the piston bore and the outer diameter of the foot valve. As used herein, “deep hole drilling” means drilling for oil and gas which can range anywhere from 100 to 3,000 meters. The run hours on the hammer, bit and foot valve can exceed 36 continuous hours, and under warm temperatures down hole of around 135 degrees Celsius. It is disadvantageous to trip that much pipe back out of the hole just to change a plastic foot valve. Presently, the cost exceeds approximately $12,000.00 a day for rig time.

The present invention aims at obviating the above-mentioned disadvantages of previously known devices. Therefore, an object of the invention is to provide a drill bit and foot valve for a percussive down-the-hole hammer which provides an extended lifespan of the foot valve.

Another object of the invention is to provide a drill bit for a down-the-hole hammer that will prevent the dislocation of the foot valve from the bit body, especially during deep hole drilling conditions.

Yet another object of the invention is to provide a foot valve for a down-the-hole drill bit that will have a longer life between service than in hitherto known percussive down-the-hole hammers.

Still another object of the invention is to provide a drill bit and a foot valve that are less sensitive to tolerance faults.

### SUMMARY OF THE INVENTION

In an embodiment, the invention provides an air-actuated down-the-hole hammer for rock drilling, including a generally cylindrical casing defining an axis, a drill sub mounted to a rear end of the casing, a drill chuck mounted to a front end of the casing, and a drill bit mounted in the drill chuck and including a front cutting face and a rear anvil portion. The anvil portion includes a rearwardly facing anvil surface. The drill bit includes a first central passage extending through the anvil surface, the passage forming a cavity adjacent to the rear anvil surface. A piston is mounted in the casing behind the drill bit and includes a forwardly facing impact surface and a second central passage extending through the impact surface and aligned with the first central passage. The piston is mounted for axial reciprocation toward and away from the drill bit whereby the impact surface impacts the anvil surface during a forward stroke of the piston. A foot valve extends partially in the first central passage and partially in the second central passage when the impact surface impacts the anvil surface for transferring pressurized air from the second central passage to the first central passage. The foot valve and the first central passage include insertion stop means and major extraction stop means for the foot valve, such that the insertion stop means are provided at a distance from the major extraction stop means.

In another embodiment, the invention provides a percussive drill bit for use in a down-the-hole hammer, including a front drilling face, a rear anvil surface, and a central passage extending through the anvil surface along a center axis of the drill bit, the passage forming a cavity adjacent to the rear anvil surface, the cavity including an undercut defined by a, at least partly, tapered portion and upper and lower ends.

In yet another embodiment, the invention provides a foot valve that is used in a drill bit passage in an air-actuated down-the-hole hammer for rock drilling, including a generally cylindrical tube defining a center line, an upper end and a lower end, the foot valve including insertion stop means and major extraction stop means, such that the insertion stop means is provided at a distance from the major extraction stop means.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention.

FIG. 1 is a down-the-hole hammer according to the present invention in a cross-sectional view;

FIG. 2A is a drill bit according to the present invention in a side elevational view;

FIG. 2B shows the drill bit at line 2B-2B in FIG. 2A;

FIG. 2C shows the drill bit in FIG. 2A in a perspective view;

FIG. 3A shows a portion of the drill bit according to the present invention, a portion of a piston, and a foot valve according to the present invention, in a cross-sectional view;

FIG. 3B shows an enlarged area, encircled in FIG. 3A;

FIG. 4A shows a foot valve according to the present invention in a side view; and

FIG. 4B shows the foot valve in an end view.

### DETAILED DESCRIPTION OF THE PREFERRED EMBODIMENTS

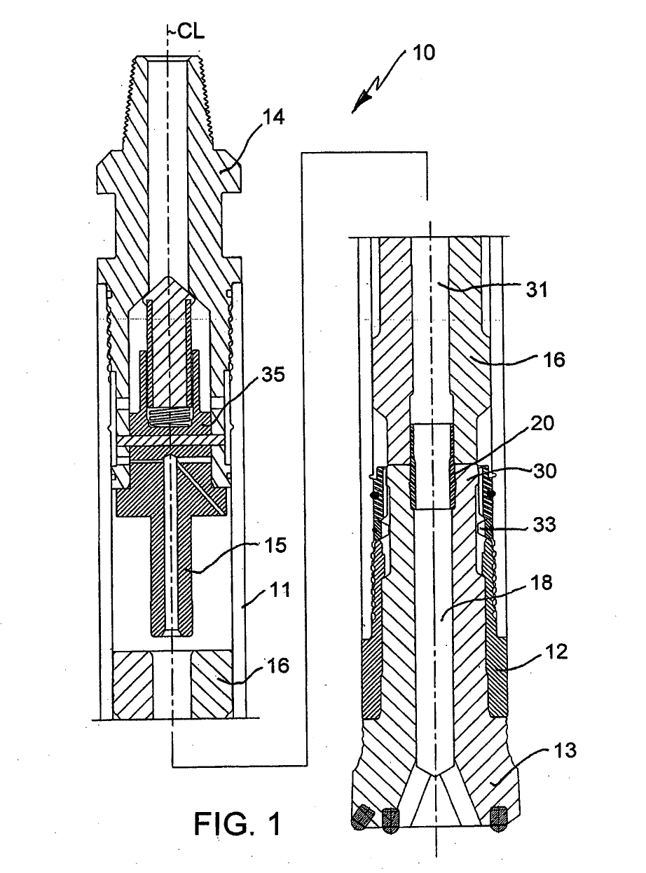

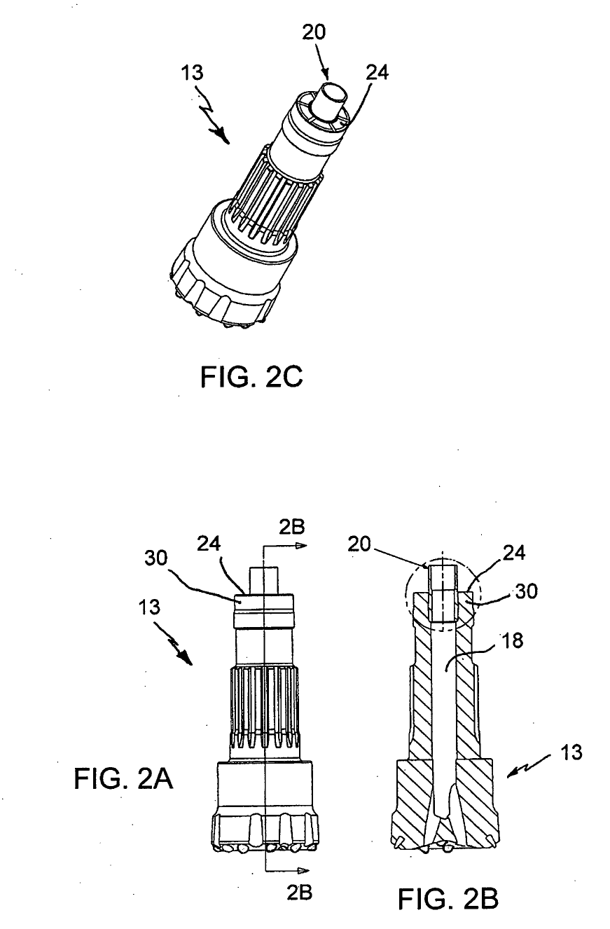

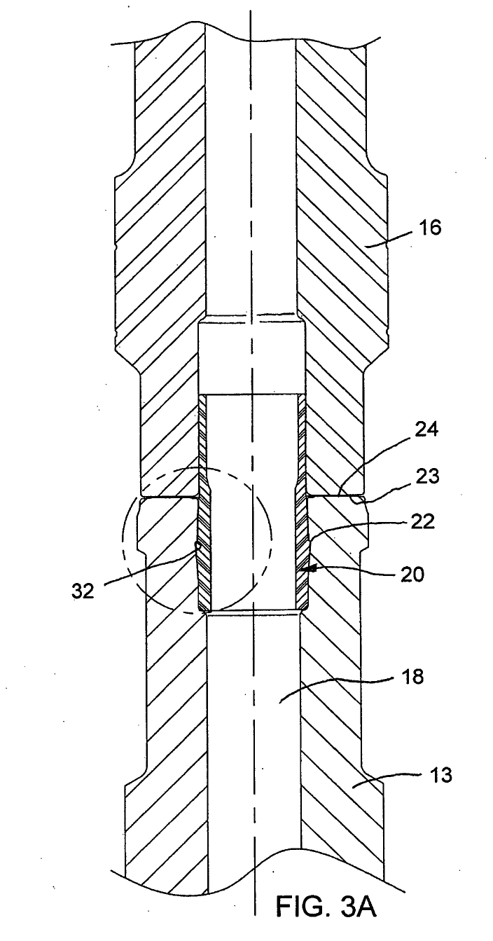

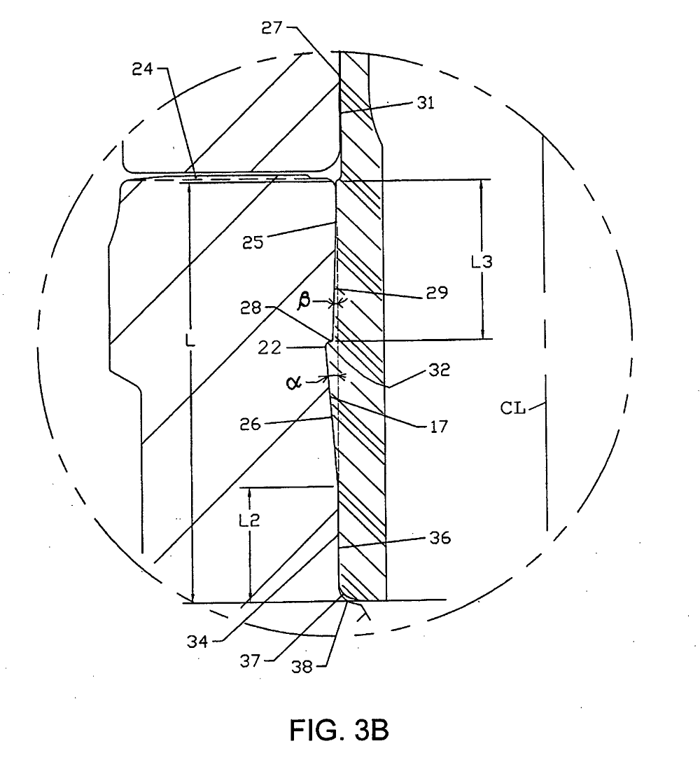

In FIG. 1 there is shown a down-the-hole hammer 10 according to the present invention. The hammer 10 includes an outer cylindrical casing 11 connectable to a rotatable drill pipe string, not shown, through which compressed air is conducted. A hammer piston 16 reciprocates in the cylindrical casing 11, and compressed air is directed alternately to the upper and lower ends of the piston to effect its reciprocation in the casing, each downward stroke inflicting an impact blow upon an anvil 30 of a drill bit 13 extending upwardly within the lower portion of the cylindrical casing. The piston includes a passage 31 for the pressurized air. The percussive down-the-hole hammer further includes a top sub 14, a check valve 35, a control or fluid feed tube 15, a foot valve 20, a retaining means 33 and a driver sub 12.

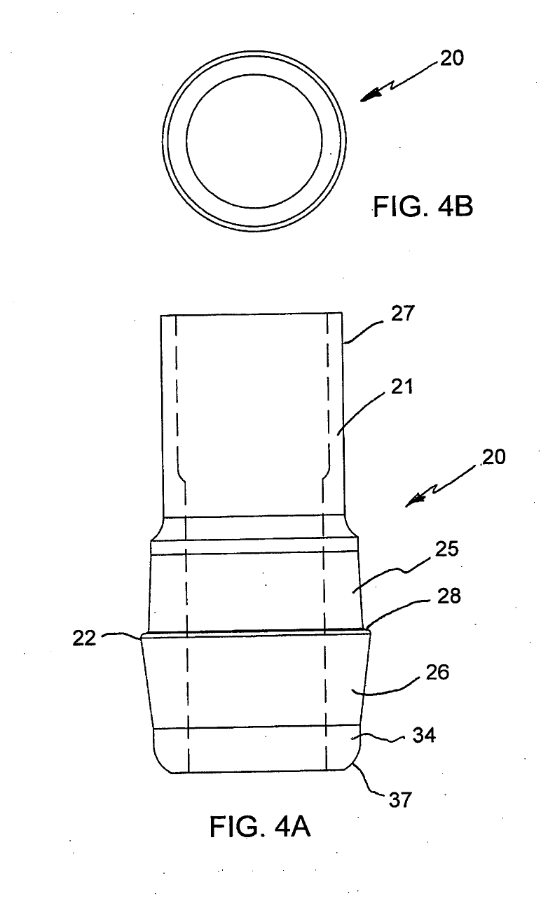

The foot valve 20 is of generally cylindrical basic shape and is made of plastics, such as Nylon® or Delrin®, as illustrated in FIGS. 4A and 4B. The foot valve is a hollow tube 21 provided with a circumferential ridge 22 defining the greatest diameter of the foot valve 20. The foot valve 20 extends further into the drill bit than into the piston 16 when the piston front surface 23 impacts on the drill bit rear surface 24. The average wall thickness of the foot valve 20 is greater at the portion entering the drill bit than the portion entering the piston. That is, the average wall thickness of a lower portion of the foot valve is greater than an upper portion of the foot valve.

The ridge 22 is provided to keep the foot valve in the drill bit by pressing the ridge into a corresponding annular groove, or fourth tapered portion 17, in a cavity in a drill bit passage 18. The cavity is formed adjacent to the anvil. The ridge 22 is formed between a first tapered portion 25 and a second tapered portion 26. The tapered portions 25, 26 slope away from the ridge 22.

The first tapered portion 25 is provided adjacent to a first valve portion 27, which is preferably cylindrical. The first valve portion 27 is received by the piston passage 31 to close off a bottom air vent of the hammer when the piston descends upon the portion 27. The first valve portion 27 has a relatively small wall thickness. The first tapered portion 25 inclines at an angle β of approximately 1.5-2.5 degrees relative to a center line of the foot valve 20 or a center line CL of the hammer 10, i.e. the first portion 25 tapers axially towards the piston 16. The first tapered portion 25 may have an interference fit with a complementary first cavity portion or third tapered portion 29 in the drill bit passage 18. The inclination of the first cavity portion 29 is chosen similar to the angle β. The interference fit resists pull out and counters the pulling forces from the piston 16 during its upward cycle. It also adds more wall thickness to the foot valve to make it a stronger area.

The second tapered portion 26 inclines at an angle a of approximately 3-6 degrees relative to the center line of the foot valve 20 or the center line CL of the hammer 10, i.e. the second portion 25 tapers axially towards the drill bit 13. That is, the second tapered portion 26 inclines in the opposite direction relative to the angle β. The angle α can be 3-6 degrees depending on the diameter or size of the foot valve. The angle α reduces the amount of force required to install the foot valve into the drill bit passage 18, thereby reducing the amount of deformation and/or damage that can be caused to the foot valve during the installation process and will further reduces the possibility of premature foot valve failure.

The angle β provides added retaining force at the foot valve into the bit body by creating a downward pulling force as well as accounting for any tolerance differences in the manufacturing processes thereof.

An external, annular shoulder 28 can be formed at the junction of the tapered portions 25, 26. The shoulder 28 has a generally radial extension. The shoulder is snaps into and cooperates with an annular collar 32, or upper end of an undercut, in the passage 18, which in turn provides the strongest holding feature and ensures against extraction. The shoulder 28 and the collar 32 may also be called major extraction stop means.

A guide portion 34 is provided at the lower end of the foot valve. The guide portion 34 is substantially cylindrical and acts as a lower guide bushing in cooperation with a lower guide surface 36 of the passage 18. The guide portion and the guide surface have the same measurements in diameter and are preferably not press fit as are other features discussed above. The guide portion 34 and the guide surface 36, each connects to a nose end 37 and a second collar 38 or lower end of an undercut, respectively. The nose end 37 and the second collar 38 prevent further insertion of the foot valve into the passage 18 as the foot valve will bottom out in the passage. The nose end 37 and the second collar 38 can be rounded or chamfered. The nose end 37 and the second collar 38 may also be called insertion stop means. The insertion stop means are provided at a distance, at least 12 mm, from the major extraction stop means. An undercut is thus defined in the passage 18 by the tapered portion 17, the guide portion 36 and upper 32 and lower ends 38.

Mounting of the foot valve is done as follows. The foot valve 20 is aligned with the drill bit passage 18 such that a guide portion 34 may be inserted into the first cavity portion 29 of the passage. The nose end 37 enters into the passage more easily if the nose end is rounded or chamfered. The second tapered portion 26 may abut against the passage when the entire guide portion has entered the passage 18. The force needed for insertion of the foot valve gradually increases due to the increasing diameter of the portion 26 until the ridge 22 enters the passage 18. The force needed for further insertion of the foot valve gradually decreases due to the increasing diameter of the cavity portion 29 upon which the ridge rides until the ridge snaps into the collar 32 in the passage 18. If the foot valve is pushed a small additional distance, less than 5 mm, the insertion stop means 37, 38 will define the maximum possible inserted length L of the foot valve. The inserted length L of the foot valve into the drill bit is typically 40 to 70 mm, and about 60 mm in the shown example. The distance L3 between the major extraction means 28, 32 and the impact surface 24 of the drill bit is 15-30 mm. The distance L2 between the insertion stop means 37, 38 and the upper portion of the guide portions 34, 36 is 20-40 mm. When the hammer is in use and the piston travels upwardly, the piston passage 31 will tend to grip the foot valve and lift it from the drill bit passage. However, such a motion of the foot valve will be stopped primarily by the major extraction stop means, i.e. the shoulder 28 and the collar 32. Also, the first tapered portion 25 and the first cavity portion 29 in the drill bit passage 18 aid to some extent in preventing the extraction.

A drill bit and a foot valve according to the present invention will provide for an extended lifespan of the hammer before service is needed. Furthermore, a down-the hole hammer according to the present invention will have a more reliable function and more economical usage than hitherto known hammers. In addition, the down-the-hole hammer is less sensitive to tolerance faults.

The terms “lower”, “upper”, “upwardly” and similar terms used herein refer to the normal position of a hammer situated vertically in a hole.

While the invention has been disclosed with reference to certain preferred embodiments, numerous modifications, alterations, and changes to the described embodiments are possible without departing from the sphere and scope of the invention, as defined in the appended claims and their equivalents thereof. Accordingly, it is intended that the invention not be limited to the described embodiments, but that it have the full scope defined by the language of the following claims.

1. An air-actuated down-the-hole hammer for rock drilling, comprising:
a generally cylindrical casing defining an axis;
a drill sub mounted to a rear end of the casing;
a drill chuck mounted to a front end of the casing;
a drill bit mounted in the drill chuck and including a front cutting face and a rear anvil portion, the anvil portion including a rearwardly facing anvil surface, the drill bit including a first central passage extending through the anvil surface, the passage forming a cavity adjacent to the rear anvil surface;
a piston mounted in the casing behind the drill bit and including a forwardly facing impact surface and a second central passage extending through the impact surface and aligned with the first central passage, the piston mounted for axial reciprocation toward and away from the drill bit whereby the impact surface impacts the anvil surface during a forward stroke of the piston;
a foot valve extending partially in the first central passage and partially in the second central passage when the impact surface impacts the anvil surface for transferring pressurized air from the second central passage to the first central passage;
the foot valve and the first central passage including insertion stop means and major extraction stop means for the foot valve, wherein the insertion stop means are provided at a distance from the major extraction stop means.

2. The hammer according to claim 1, wherein the insertion stop means are provided at least 12 mm from the major extraction stop means.

3. The hammer according to claim 1, wherein the major extraction stop means include an external annular shoulder having a generally radial extension in the foot valve and an annular collar of a generally radial extension in the first central passage.

4. The hammer according to claim 1, wherein the major extraction stop means connect to axially tapered portions located on opposite axial sides of the major extraction stop means.

5. The hammer according to claim 4, wherein the tapered portions taper in opposite directions such that first and third portions taper towards the piston and second and fourth portions taper towards the drill bit.

6. The hammer according to claim 5, wherein the first and third portions taper at an angle of 1.5-2.5 degrees relative to a center line of the hammer.

7. The hammer according to claim 5, wherein the second and fourth portions taper at an angle of 3 -6 degrees relative to a center line of the hammer.

8. A percussive drill bit for use in a down-the-hole hammer, comprising:
a front drilling face;
a rear anvil surface; and
a central passage extending through the anvil surface along a center axis of the drill bit, the passage forming a cavity adjacent to the rear anvil surface, the cavity including an undercut defined by a, at least partly, tapered portion and upper and lower ends.

9. The drill bit according to claim 8, wherein the upper and lower ends are provided at least 12 mm from each other.

10. The drill bit according to claim 8, wherein the lower end has a generally radial extension in the central passage.

11. The drill bit according to claim 8, wherein the upper end connects to axially tapered portions located on opposite axial sides of the upper end.

12. The drill bit according to claim 11, wherein the tapered portions taper in opposite directions such that a third portion tapers towards the rear anvil surface and a fourth portion taper towards the front drilling face.

13. The drill bit according to claim 12, wherein the third portion tapers at an angle of 1.5 -2.5 degrees relative to a center line of the drill bit.

14. The drill bit according to claim 13, wherein the fourth portion tapers at an angle of 3 -6 degrees relative to a center line of the drill bit.

15. A foot valve that is used in a drill bit passage in an air-actuated down-the-hole hammer for rock drilling, comprising:
a generally cylindrical tube defining a center line, an upper end and a lower end;
the foot valve including insertion stop means and major extraction stop means, wherein the insertion stop means is provided at a distance from the major extraction stop means.

16. The foot valve according to claim 15, wherein the insertion stop means is provided at least 12 mm from the major extraction stop means.

17. The foot valve according to claim 15, wherein the major extraction stop means includes an external annular shoulder having a generally radial extension.

18. The foot valve according to claim 15, wherein the major extraction stop means connects to axially tapered portions located on opposite axial sides of the major extraction stop means.

19. The foot valve according to claim 18, wherein the tapered portions taper in opposite directions such that a first portion tapers towards the upper end and a second portion tapers towards the lower end.

20. The foot valve according to claim 18, wherein the first portion tapers at an angle of 1.5 -2.5 degrees relative to a center line of the foot valve.

21. The foot valve according to claim 16, wherein the second portion tapers at an angle of 3 -6 degrees relative to a center line of the foot valve.

22. The foot valve according to claim 15, wherein the average wall thickness of a lower portion of the foot valve is greater than the average wall thickness of an upper portion of the foot valve.
